(19) United States
(12) Patent Application Publication
(10) Pub. No.: US 2002/0146105 A1
(43) Pub. Date: Oct. 10, 2002

(54) Interactive call forwarding

(75) Inventor: Joseph Herbert McIntyre, Austin, TX (US)

Correspondence Address: Robert V. Wilder, Attorney at Law, 4235 Kingsburg Drive, Round Rock, TX, 78681, US

(73) Assignee: International Business Machines Corporation, Armonk, NY (US)

(21) Appl. No.: 09/826,666

(22) Filed: Apr. 5, 2001

(51) Int. Cl. H04M 3/42

(52) U.S. Cl. 379/211.02; 379/212.01

(57) ABSTRACT

A method and implementing system are provided in which a user to a telephone call forwarding service is notified on a portable device when an incoming call to the user's primary phone number has been detected. The incoming phone number and/or entity is displayed to the user and the user is given an option to have the call forwarded to a new number which may be input by the user, or to have the call transferred to a voice mail or other processing system. In an exemplary embodiment, a selected message is played to the caller while the user is being located by the telephone call forwarding application.

### FIELD OF THE INVENTION

The present invention relates generally to information processing and more particularly to a methodology and implementation for telephone call forwarding systems.

### RELATED APPLICATIONS

Subject matter disclosed and not claimed herein is disclosed and claimed in related co-pending application, Attorney Docket AUS920010294US1, which is assigned to the assignee of the present application.

### BACKGROUND OF THE INVENTION

Advancing telephone technologies have resulted in many new telephone-related devices and telephone call-processing techniques. One such processing technique is call forwarding processing. Call forwarding provides a mechanism to have an incoming phone call transferred to another location for a temporary period of time. This is useful when it is known that a person will be away from the person's regular office phone for example, and the number of the phone at the temporary location is known. A phone call made to the original location or office can automatically be routed to the new location by a telephone network application server when a user or subscriber to the service inputs the necessary information along with the new temporary phone number. However, if the person does not know where they will be, and does not have a mobile or wireless phone, for example, the forwarding function has not been useful.

Further, there are many situations where a person is travelling among many locations during the day and does not know a phone number or time at which the person can be reached until the person has arrived at one of the locations. In the past, call forwarding has not been useful under these conditions since the forwarding number had to be input at the person's originating office phone.

Thus, there is a need for an improved call forwarding processing technique which provides greater flexibility and control to a telephone service user over the routing of phone calls which are made to the user at a first location when the user is away from the first location.

### SUMMARY OF THE INVENTION

A method and implementing system are provided in which a user of a telephone call forwarding service is notified on a portable device when an incoming call to the user's primary phone number has been detected. The incoming phone number and/or entity is displayed to the user and the user is given an option to have the call forwarded to a new number which may be input by the user, or to have the call transferred to a voice mail or other processing system. In one exemplary embodiment, a selected message is played to the caller while the user/subscriber is being located by the telephone call forwarding service application.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of a telephone environment in which the present invention may be implemented;

FIG. 2 is an exemplary block diagram of several of the major components of a computer system in which the present invention may be implemented;

FIG. 3 is a flow chart illustrating a partial exemplary operational sequence of an interactive call forwarding methodology;

FIG. 4 is a continuation of the flow chart illustrated in FIG. 3;

FIG. 5 is an illustration of a screen display of a menu which may be used in an implementation of the sequence shown in FIG. 3 and FIG. 4;

FIG. 6 is an illustration of another screen display of a menu which may be used in a selective call forwarding methodology; and

FIG. 7 is a flow chart of an exemplary operational sequence which may be used in an implementation of the selective call forwarding methodology.

### DETAILED DESCRIPTION

The various methods discussed herein may be implemented with a typical computer server which may include a workstation or other computer systems. For example, the exemplary telecom application server may be comprised of a telecom server device (e.g. telecom feature server) or workstation device while the disclosed portable or wireless devices which may be used in connection with the server include devices such as two-way pagers, wireless personal digital assistants (PDAs) and/or cellular phones or other portable or wireless devices which are arranged to communicate with the system telecom application server. In general, an implementing server and/or wireless device may include a plurality of processors in a multi-bus system and may be one of a network of similar systems. However, since the workstation or computer system server used in practicing the present invention in an exemplary embodiment, is generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention.

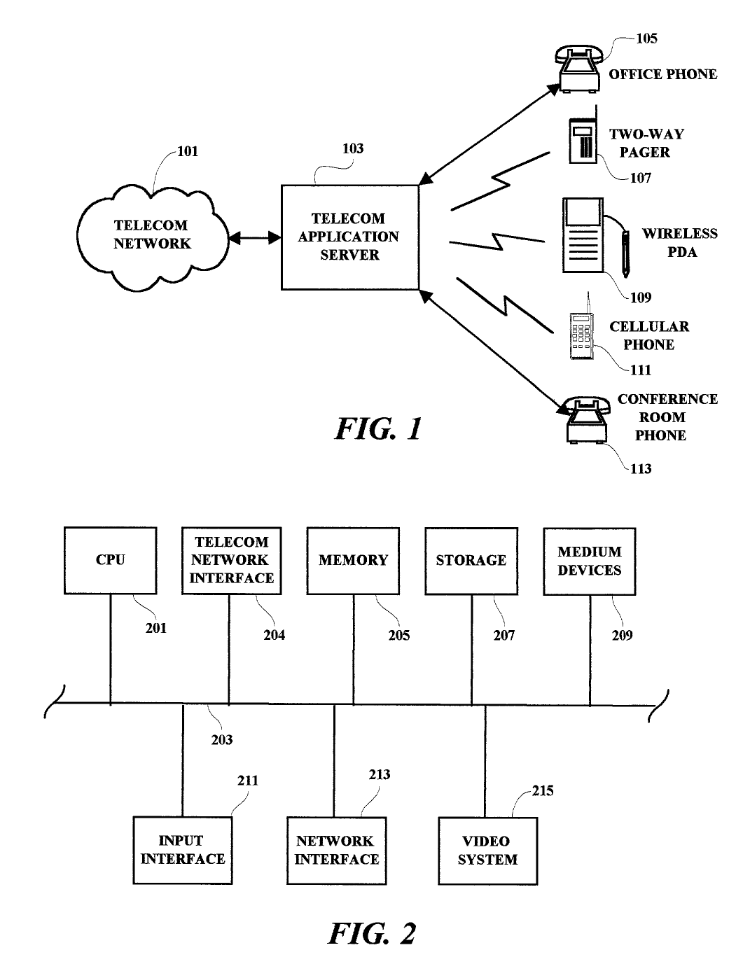

In FIG. 1, there is shown an illustration of a telephone environment in which the present invention may be implemented. As shown, a telecom network 101 is coupled to a telecom application server 103. The server 103 may be connected to other networks and servers in a distributed system. The server 103 is arranged to provide telecom application services to subscribers or users of the service. The terms “user” and “subscriber” are used interchangeably herein to refer to an entity who is using a call forwarding system as described. The server is configured to execute telecom applications and communicate with a number of remote wired and wireless devices. Such devices include, for example, a typical office telephone 105, a two-way pager 107, a wireless personal digital assistant (PDA) 109, a cellular phone 111 and a conference room phone 113. The conference room phone 113 represents a phone at a location to which a user is travelling from the user's office phone 105. The pager 107, PDA 109 and cell phone 111 represent portable devices which may be carried by the user in travelling from the office phone 105 to the conference room phone 113. It is noted that the portable devices may include additional similar devices. All of the portable devices in the present example have the capability to present text messages, and thus displayed menus as well, to a user, and to receive and transmit return input from the user to the sending device, for example, the telecom application server 103. Thus, with each of the portable devices shown, a user is able to receive a text or other displayed message from the server 103, and the user is able to input and return text and/or numerals to the sending server 103. The server 103 is programmed to execute telecom applications from memory and communicate with one or more of the portable devices or fixed telephone units as shown.

In FIG. 2, several of the major electronic subsystems within the server device 103 are illustrated. As shown, a processor 201 is coupled to a system bus 203 which may be any host system bus. It is noted that the processing methodology disclosed herein will apply to many different bus and/or network configurations although only one example is illustrated. A memory subsystem 205, a storage device 207 and selected medium devices 209 (such as a diskette drive or a CD drive) are also shown connected to the system bus 203. The information processing circuitry illustrated in FIG. 2 is arranged to establish a communication link and initiate communication with the user devices as shown in FIG. 1. The server 103 is connected through a telecom network interface 204 to the telecom network 101. The server 103 may also be connected through a network interface connection 213 to any appropriate network 101, including the Internet, from which incoming calls for the user devices are initially received and returned. The exemplary system also includes an input interface 211 to enable administrator input to the server system, and also a video system for display of various aspects of the telecom and other applications being executed on the server 103.

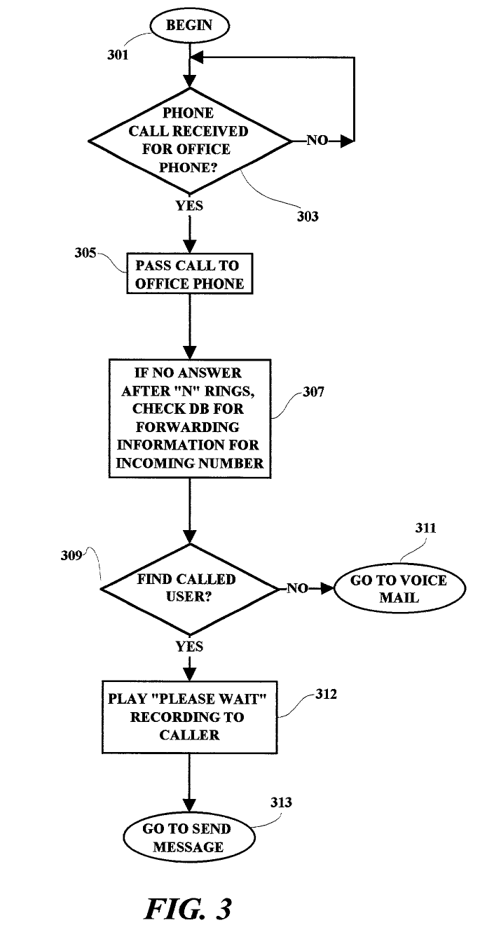

An exemplary call forwarding methodology is illustrated in the flow chart of FIG. 3. As shown, the processing begins 301 when it is detected that a call has been received 303 from the telecom network 101 for example, for the office phone 105. The call is routed to the office phone 105, and if there is no answer after a predetermined number of rings, a forwarding database DB is checked for appropriate forwarding information for the phone 105. The forwarding database may, for example, be stored in server storage 207 and accessed by the CPU 201 to determine forwarding information. The database will contain the phone number of the phone 105 along with additional information with regard to the processing of the incoming call. For example, the forwarding database will contain a designation as to whether or not to “find” the user for incoming calls 309. If the user had indicated not to forward calls, then the call is directed to a voice mail system 311. If the database indicates that the user wants to be found for incoming calls 309, then a “PLEASE WAIT” recording may be played to the caller 312 while the processing continues with a message sending function 313.

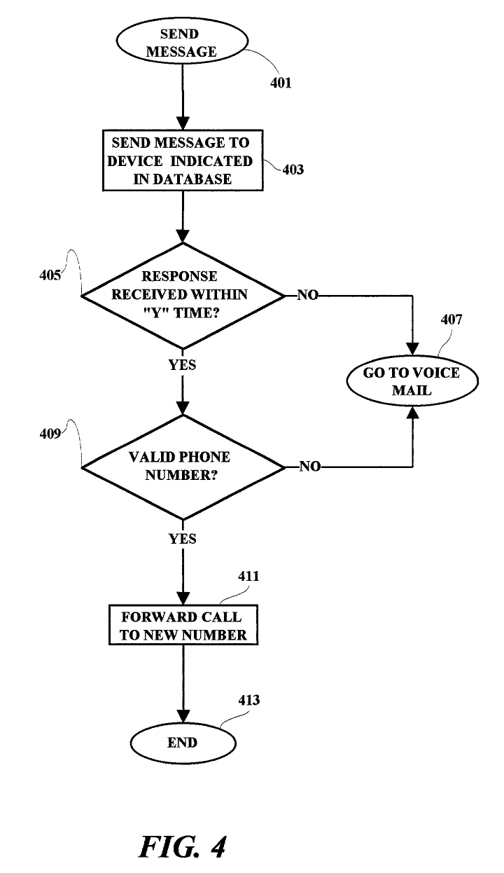

As shown in FIG. 4, the message sending function 401 is operable to send a message 403 to the user at the user's portable device as taken from the forwarding database for the given office phone. The message sent by the server is operable to effect a display of a menu to the user on the user's portable device, which may be either the two-way pager 107, the PDA 109 or the cellular phone 111. The user option menu displayed on the portable device may be in a full menu format or merely as a text message with menu selection numbers or other indicia as hereinafter illustrated. The display of the menu may be triggered by the message from the server 103 and generated from memory in the portable device, or the menu may be stored at the server and transmitted from server memory. When the message is received at the user's portable device, an alarm will sound. If the user does not respond to the incoming message from the server within a predetermined amount of time “Y” (e.g. 20 seconds), then the call is directed to the voice mail system 407. If the user responds within the predetermined time and inputs a valid phone number of a phone where the user wishes the call to be transferred, then the process continues and checks the input phone number for validity 409. If the input phone number is not a valid phone number, then the call is sent to voice mail 407. If, however, the input forward phone number is determined to be a valid number 409, then the call is sent to the new or forward number 411 which was input by the user, and the process ends 413. It is noted that the forward phone number may be the number of a conference room phone where the user is waiting so that the incoming call may be placed on a speaker phone, or the forward number may be the number of the portable device which is in the possession of the user. The above methodology is practiced on a real time basis such that the user is free to input forward phone numbers for incoming calls depending on where the user is at the particular time that the incoming call is received. The user also has the option of not responding to the server message, in which case a default processing occurs such as the voice mail processing shown in the example.

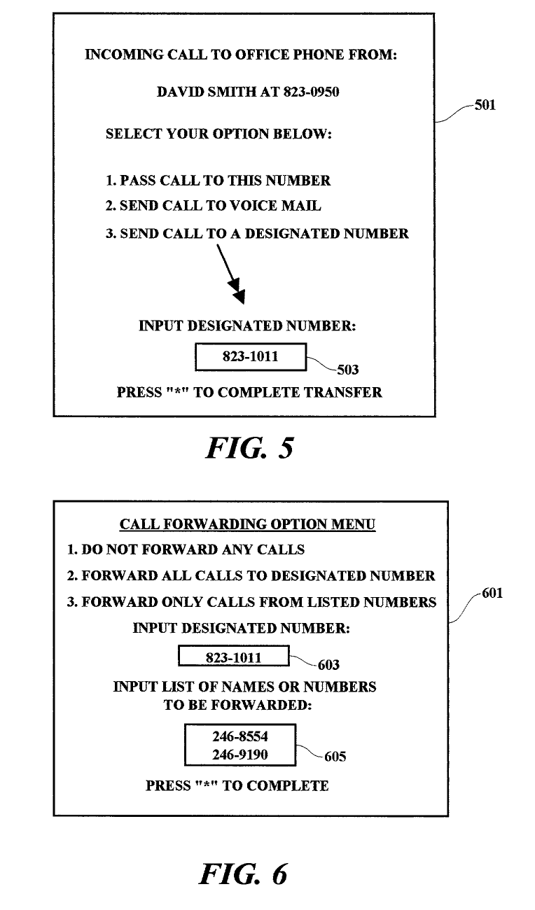

An example of a user option menu which may be displayed on the user's portable device when an incoming call is notified to the user, is illustrated in FIG. 5. As shown, a display 501 indicates that there is an incoming call to the user's office phone and also the name and/or number of the person calling. The user is prompted to select one of three possible options in the example. The user may choose number “1” to direct the server to pass the call to the number of the user's portable device if a cellular phone, or the user may select the number “2” to direct the server to send the call to the voice mail system, or the user may select number “3” to send the call to a designated phone number. If the user selects number “3”, an input box appears and the user is enabled to input the forward number 503 and hit the “star” key, for example, to complete the transaction.

As shown in FIG. 6, a second call forwarding methodology may be implemented using a similar menu-type processing. The menu illustrated in FIG. 6 may reside in the user's portable memory and be called up when the user selects from a more generalized main menu for the device. When the FIG. 6 menu is displayed on the user's portable device screen 601, the user is enabled to pro-actively designate only the particular calls which the user wishes to have forwarded to the user's cell phone or another designated phone. For example, if the user is going to an important meeting, the user may not wish to have all calls forwarded to the user's portable device since it may too frequently interrupt the meeting. However, if, for example, the user's wife is expecting, or the user has a large stock transaction pending, the user may want only those calls to be forwarded to the user's portable device number or another number. By selecting the numeral “1”, the user indicates that the server is not to forward any calls. A selection of the numeral “2” in the example indicates that the user wishes to forward all incoming calls to a designated number. Thus, a user is enabled to make a decision to forward all calls to a designated number even when the user is away from the user's office phone 105. By selecting the numeral “3” the user may choose to have only selected incoming calls routed to the designated forward number. If the user chooses the selected call forwarding feature “3”, the user is enabled to input the forward number 603 and also numbers of expected or important calls 605. The user then hits the “star” key for example, and the input information is sent to the server database for processing future calls coming into the user's office phone. Other user interfaces appropriate to devices having different capabilities may be implemented according to the device's capabilities.

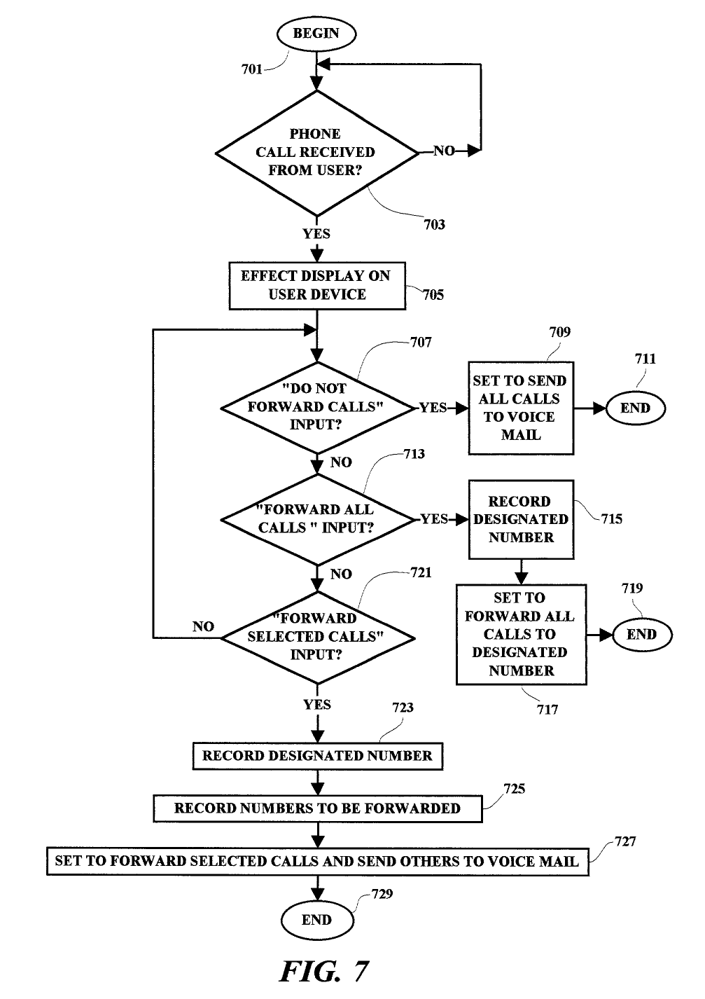

As shown in FIG. 7, the selective call forwarding feature begins 701 when a call is received 703 from the user's portable device. Next the menu illustrated in FIG. 6 is caused to be presented 705 on the user's portable device. Next, if it is detected that the number “1” was selected corresponding to a selection not to forward any calls 707, then all calls are sent to a default routine such as voice mail 709 and the process ends 711. If it is detected that the numeral “2” was selected corresponding to a selection to forward all calls to a designated number 713, then the designated number is recorded 715 and a field is set in the server database which is effective to forward all incoming calls to the number designated by the user 717 and the process ends 719. If neither “1” nor “2” has been keyed in by the user on the user's portable device but the number “3” has been pushed, then the user has selected to forward only selected calls to a designated number 721. In that case, the designated number input by the user is recorded 723, as well as the specific incoming call numbers which are also input by the user 725. The server processing is then set 727, for example by setting a “selective call forwarding” field in the database, such that all calls from the selected phone numbers are forwarded to the designated number, and other calls are handled with a default routine such as voice mail, and the process ends 729. Using the selected call forwarding feature, a user is able to specify only identified calls to be forwarded to a designated number input by the user.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely in program code and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for forwarding an incoming telephone call from a first number to a second number, said method comprising:
receiving said incoming telephone call by a processing system;
sending a message to a user device for routing information regarding said incoming telephone call;
receiving routing information from said user device responsive to said message; and
transferring said incoming telephone call in accordance with said routing information.

2. The method as set forth in claim 1 wherein said routing information includes said second number, whereby said incoming telephone call is thereafter transferred to said second number.

3. The method as set forth in claim 1 wherein after said receiving, said method further includes accessing processing information, said processing information including an access method for said user device.

4. The method as set forth in claim 1 wherein said user device is a wireless device.

5. The method as set forth in claim 1 wherein said user device includes input means for enabling said user to input information, said information including said second number.

6. The method as set forth in claim 4 wherein said wireless device is a cell phone.

7. The method as set forth in claim 4 wherein said wireless device is a two-way pager device.

8. The method as set forth in claim 4 wherein said wireless device is a computing device.

9. The method as set forth in claim 4 wherein said wireless device is a laptop computer.

10. The method as set forth in claim 1 wherein said processing information includes information determinative of whether said sending occurs or whether said incoming telephone call is transferred to a default processing system without said sending of said message to said user device.

11. The method as set forth in claim 10 wherein said default processing system is a voice mail processing system.

12. The method as set forth in claim 1 and further including playing a recorded message to a caller of said incoming telephone call for at least a portion of time during said sending.

13. The method as set forth in claim 1 and further including transferring said incoming telephone call to a voice mail processing system if said routing information is not received within a predetermined period of time after said sending.

14. The method as set forth in claim 1 and further including determining if said routing information includes a valid second number prior to said transferring.

15. The method as set forth in claim 14 and further including transferring said incoming telephone call to a voice mail processing system if said routing information does not include a valid second number.

16. A storage medium including machine readable coded indicia, said storage medium being selectively coupled through a reading device to processing circuitry within a computing system, said reading device being selectively operable to read said machine readable coded indicia and provide program signals representative thereof, said program signals being effective to enable a forwarding of an incoming telephone call from a first number to a second number, said program signals being selectively operable for effecting steps of:
receiving said incoming telephone call by a processing system;
sending a message to a user device for routing information regarding said incoming telephone call;
receiving routing information from said user device responsive to said message; and
transferring said incoming telephone call in accordance with said routing information.

16. The medium as set forth in claim 15 wherein said routing information includes said second number, whereby said incoming telephone call is thereafter transferred to said second number.

17. The medium as set forth in claim 15 wherein after said receiving, said steps further include accessing processing information, said processing information including an access method for said user device.

18. The medium as set forth in claim 15 wherein said user device is a wireless device.

19. The medium as set forth in claim 15 wherein said user device includes input means for enabling said user to input information, said information including said second number.

20. The medium as set forth in claim 18 wherein said wireless device is a cell phone.

21. The medium as set forth in claim 18 wherein said wireless device is a two-way pager device.

22. The medium as set forth in claim 18 wherein said wireless device is a computing device.

23. The medium as set forth in claim 18 wherein said wireless device is a laptop computer.

24. The medium as set forth in claim 15 wherein said processing information includes information determinative of whether said sending occurs or whether said incoming telephone call is transferred to a default processing system without said sending of said message to said user device.

25. The medium as set forth in claim 24 wherein said default processing system is a voice mail processing system.

26. The medium as set forth in claim 15 wherein said steps further include playing a recorded message to a caller of said incoming telephone call for at least a portion of time during said sending.

27. The medium as set forth in claim 15 wherein said steps further include transferring said incoming telephone call to a voice mail processing system if said routing information is not received within a predetermined period of time after said sending.

28. The medium as set forth in claim 1 wherein said steps further include determining if said routing information includes a valid second number prior to said transferring.

29. The medium as set forth in claim 28 wherein said steps further include transferring said incoming telephone call to a voice mail processing system if said routing information does not include a valid second number.

30. A processing system including a system bus, and a processor, a memory system, and a network interface, all coupled to said system bus, said processing system being operable for forwarding an incoming telephone call from a first number to a second number, said processing system being arranged for receiving said incoming telephone call and sending a message to a user device for routing information regarding said incoming telephone call, said processing system being further operable for receiving routing information from said user device responsive to said message, and transferring said incoming telephone call in accordance with said routing information.
